(19) United States
(12) Patent Application Publication
(10) Pub. No.: US 2014/0154509 A1
(43) Pub. Date: Jun. 5, 2014

(54) PROVIDING A CATLYST FREE DIAMOND LAYER ON DRILLING CUTTERS

(71) Applicant: DIAMOND INNOVATIONS, INC., Worthington, OH (US)

(72) Inventors: Hui Zhang, Columbus, OH (US); Andrew Gledhill, Westerville, OH (US); Abds-Sami Malik, Westerville, OH (US); Joel Vaughn, Groveport, OH (US)

(73) Assignee: DIAMOND INNOVATIONS, INC., Worthington, OH (US)

(21) Appl. No.: 13/705,832

(22) Filed: Dec. 5, 2012

(51) Int. Cl. B23B 27/20; B23B 27/14

(52) U.S. Cl. CPC B23B 27/20; B23B 27/148
USPC 428/408; 156/304.6

(57) ABSTRACT

A method of making a polycrystalline diamond compact including providing a layer of graphene on top of a sintered PCD and transforming the graphene at high pressure and temperature into diamond that is free of metal catalyst. A method of making PCD by providing a layer of graphene powder on top of a layer of diamond powder and sintering at high pressure and temperature to transform the graphene into diamond that is free of metal catalyst at the surface.

### TECHNICAL FIELD AND INDUSTRIAL APPLICABILITY

The present disclosure relates to providing a sintered polycrystalline diamond (PCD) that is free of Co, W, or other metals. The PCD can be made entirely free of metals or can be free of metals on a top layer ranging in thickness from a few to several hundred microns. Furthermore, the catalyst free layer is made without the use of acids, which are often dangerous and costly to use.

This catalyst free layer may be produced during the high pressure and high temperature (HPHT) sintering process that is used to make the PCD itself. Benefits of this invention include providing a PCD that is thermally stable, that possesses improved abrasion resistance, and that may be produced more cheaply and safely than existing methods for providing catalyst free PCD.

PCD is formed by sintering diamond particles under high pressure and high temperature (HPHT) in the presence of a metal catalyst (such as cobalt, Co). Typical HPHT conditions include pressures at or above about 45 kBar and temperatures at or above about 1400° C. Carbon from the diamond particles is dissolved by, and then re-precipitated as diamond, from the metal catalyst. The presence of the metal catalyst facilitates formation of inter-particle diamond growth, which binds the diamond particles together as a sintered compact. However, the metal catalyst remains in the PCD compact after the HPHT sintering process, and the presence of the metal catalyst is detrimental to PCD performance when the compact is used in cutting and machining applications. In particular, the presence of the metal catalyst in the PCD compact may have detrimental effects on the PCD when used in intended applications.

This is because the frictional heat generated during the rock or metal cutting process promotes back conversion of the diamond to graphite, thereby leading to pre-mature wear. Also, because of differences in the coefficient of thermal expansion (CTE) between diamond and metal, the metal will expand more as the compact is heated and thereby may induce micro-cracking in the diamond compact and leading to pre-mature failure. Removing the metals from the sintered PCD is thought to be effective in mitigating these problems.

Other ways to provide a catalyst free PCD is by sintering at elevated pressure as described in Sumiya. (Sumiya, H., et al., Microstructure features of polycrystalline diamond synthesized directly from graphite under static high pressure. Journal of Materials Science, 2004. 39: p. 445-450). However, sintering conditions are so extreme (>15 GPa, >2300° C.) that this method is not economically feasible for industrial scale production. Still another way is to synthesize diamond by chemical vapor deposition (CVD). However, the rate of formation of diamond, the deposition rate, is at the order of 0.1 μm/hour, which renders this technology economically infeasible for industrial scale production.

Therefore, as can be seen, there is a need for a thermally stable, catalyst free, abrasion resistant, and strong PCD that may be produced economically and without the use of acid leaching.

### SUMMARY

In one exemplary embodiment, a cutting element for a tool may comprise a substrate; a polycrystalline diamond table bonded to the substrate; and a diamond volume substantially free of catalytic material attached to the polycrystalline diamond table, wherein the polycrystalline diamond table is sandwiched between the substrate and the diamond volume substantially free of catalytic material.

In another exemplary embodiment, a method of making a cutting element may comprise steps of positioning a diamond volume between a substrate and graphene; and sintering the graphene onto the diamond volume and the substrate. In the process of sintering, graphene is converted to diamond.

In further another exemplary embodiment, a method of making a cutting element may comprise steps of positioning a diamond volume onto a substrate; disposing a pill adjacent to the diamond volume distal from the substrate; sintering the pill to form a layer adhered to the diamond volume and secured to the substrate.

It is to be understood that both the foregoing general description and the following detailed description are exemplary and explanatory and are intended to provide further explanation of the invention as claimed.

### BRIEF DESCRIPTION OF THE DRAWINGS

FIG. 1 depicts a perspective view of a polycrystalline diamond cutter (PDC) cutter according to an exemplary embodiment;

FIG. 2 is a schematic cross-sectional view of a machined PDC cutter according to an exemplary embodiment;

FIG. 3 is a cross-sectional view of a placement of the graphene pill, diamond powder, and tungsten carbide substrate in the tantalum cup according to an exemplary embodiment;

FIG. 4 is a method of making a cutting element according to an exemplary embodiment;

FIG. 5 is a cross-sectional view of the placement of the graphene pill and sintered diamond compact on a tungsten carbide substrate in the tantalum cup according to another exemplary embodiment;

FIG. 6 is an SEM image and a corresponding EDS spectrum showing both carbon and cobalt are detected after high pressure high temperature sintering;

FIG. 7 is a Raman spectrum providing positive confirmation of diamond formation in the dark regions of a spot 1 and spot 2;

FIG. 8 is an SEM image showing the formation of diamond from graphene (dark regions) with lighter areas indicating the underlying PDC, with Co;

FIG. 9 is a magnified SEM image of FIG. 7 and corresponding an EDS spectrum showing that very little Co is detected in the dark regions; and

FIG. 10 is a plot of the wear volume of the finished PDC vs. the volume or rock removed. The cutter pressed with graphene showed improved wear resistance as compared to the standard cutter.

### DETAILED DESCRIPTION

Before the present methods, systems and materials are described, it is to be understood that this disclosure is not limited to the particular methodologies, systems and materials described, as these may vary. It is also to be understood that the terminology used in the description is for the purpose of describing the particular versions or embodiments only, and is not intended to limit the scope. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to be understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which it is being used. Therefore, about 50% means in the range of 45%-55%. When the term, “substantially free”, is used referring to catalyst in interstices, interstitial matrix, or in a volume of polycrystalline element body, such as polycrystalline diamond, it should be understood that many, if not all, of the surfaces of the adjacent diamond crystals may still have a coating of the catalyst. Likewise, when the term “substantially free” is used referring to catalyst on the surfaces of the diamond crystals, there may still be catalyst present in the adjacent interstices.

As used herein, the term “graphene” refers to a form of graphitic carbon, in which the carbon atoms are arranged in a 2-dimensional hexagonal lattice, that can be as thin as one atomic layer (<1 nm). These layers can also exist as multiple stacked sheets. The graphene particles have a very high aspect ratio such that, thickness (the z-axis) can be on the order of 100 nm (nanometers) whereas the ‘x’ and ‘y’ dimensions can be on the order of 100 μm (microns). The oxygen content of the material may be between about 1.0% to about 5.0%, in some embodiments about 1.2% to about 2.0% and in some embodiments, about 1.4%.

The sintered PDC cutters, representing a polycrystalline diamond volume bonded to a tungsten carbide cobalt substrate (WC—Co), were fabricated using the first HPHT process. After fabrication all PDC cutters were shaped by grinding and polishing to the cylindrical shape with diameter 13 mm and height 8 mm. The thickness of polycrystalline diamond table was about 2 mm. Finally, a chamfer (0.5 mm, 45°) was made on the top edge of polycrystalline diamond table of each cutter. After shaping completion, the cutter's surface was cleaned by sand blasting using SiC beads.

Raman spectroscopy was performed on a Horiba LabRAM HR instrument using 785 nm and 532 nm laser excitation with a 600 grating and an aperture size between 100 μm and 1000 μm. A 50× objective lens was used, and collection time was for 10 second each for 20 accumulations.

Scanning electron microscopy (SEM) and elemental analysis (EDS) were performed on a 4500 Hitachi SEM with 25 kV accelerating voltage. EDS was done with an Oxford XMAX with solid state detector.

Exemplary embodiments disclose a cutting element for a tool and a method of making the cutting element. In an exemplary embodiment, a pill made from graphene, or fullerene may be loaded into a tantalum cup. The fullerene may comprise C₆₀, C₇₀, carbon nanotubes, for example. Into this cup may be placed diamond powder or sintered diamond table and a tungsten carbide substrate. This assembly may be loaded into a HPHT cell and pressed at up to 75 kBar and up to 1600° C. The recovered part has a layer of diamond, the top of which is free of cobalt or other metal catalysts.

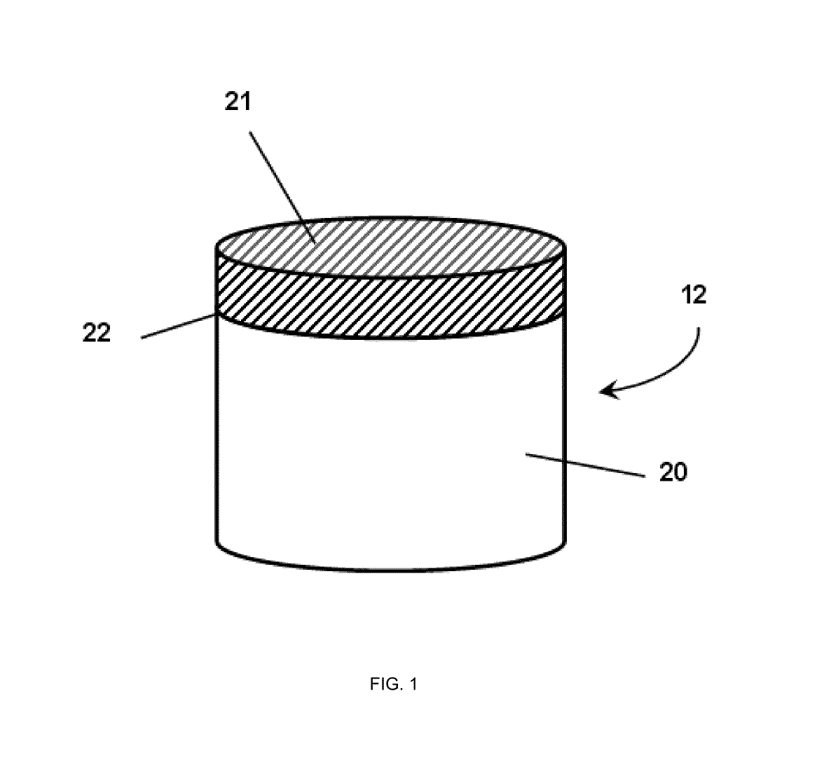

FIG. 1 shows a schematic perspective view of a cylindrical shape PDC cutter 12 produced in a high pressure high temperature (HPHT) process with a catalytic material, such as cobalt, according to an exemplary embodiment. The PDC cutter 12 may comprise a substrate 20, which is made of hard metal, alloy, or composite, such as cemented carbide or cobalt sintered tungsten carbide (WC—Co); and a polycrystalline diamond composite volume 21. PDC cutter blank may be later machined to a desired shape and dimensions.

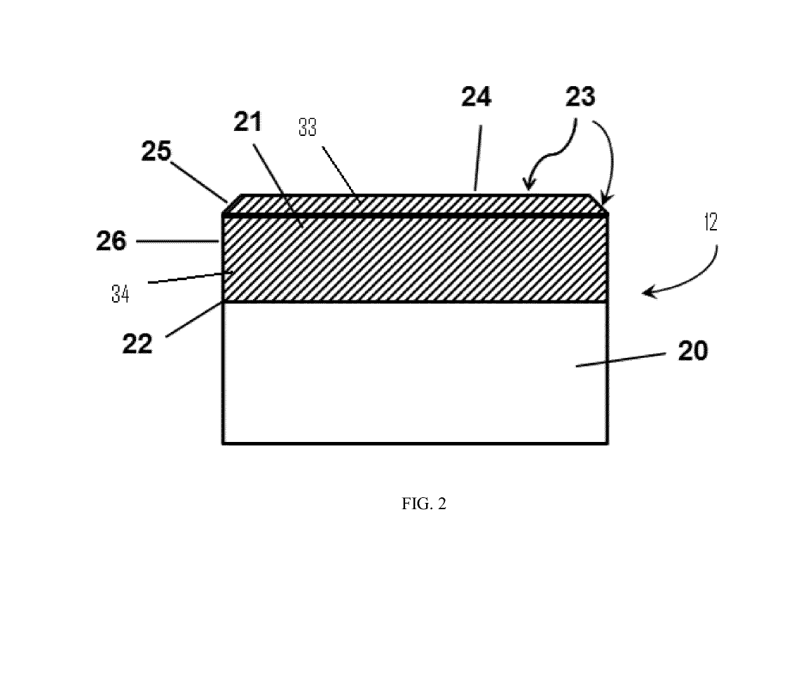

FIG. 2 shows a side view of a machined PDC cutter 12 according to an example embodiment. The polycrystalline diamond composite 21 may further include a polycrystalline diamond table 34 bonded to the substrate 20 and a diamond volume 33 substantially free of catalytic material attached to the polycrystalline diamond table 34. The polycrystalline diamond table 34 may be sandwiched between the substrate 20 and the diamond volume 33 substantially free of catalytic material. The polycrystalline diamond table may be rich in catalyst, as it is left after the HPHT process, and attached or joined coherently to the substrate along the interface 22 between the substrate 20 and the diamond volume 33. The catalytic material may be present as a sintering aid in manufacturing the polycrystalline diamond table 34. Very often, such catalyst, as cobalt metal or its alloys may be present as a diamond bond forming aid in HPHT manufacture of the polycrystalline diamond table 34.

The polycrystalline diamond volume 33 substantially free of catalytic material may be converted from graphene, fullerene under high pressure high temperature. Without intending to be bound to any particular theory, it may appear that under high pressure high temperature, p-electrons on carbon atoms of graphene or fullerene may attract every other carbon atom on graphene to cause the carbon to pucker, thus forming a diamond material as sp³ carbon bond from sp² carbon bond graphene or fullerene.

Still in FIG. 2, the PDC cutter 12 may comprise a working surface 23 that includes a planar upper surface 24, and a side surface 26. The PDC cutter 12 may further comprise a bevel 25 at a peripheral edge. As it is appreciated, the shape of PDC cutter described here does not limit the scope of current disclosure and PDC cutters may have a variety of shapes.

In one exemplary embodiment, the polycrystalline diamond table 34 may be a leached polycrystalline diamond table. Thus, in an exemplary embodiment described here, the surface of machined PDC cutter 12 was treated in a mixture of acids in order to remove a surface layer of a catalyst. The polycrystalline diamond table 34 may be depleted in cobalt to a necessary one or several depths from, correspondently: an outer peripheral upper surface 24, chamfer 25, or an outer peripheral side surface 26. The polycrystalline diamond table 34 rich in catalyst may extend along the side surface 26 but does not reach the interface 22 with the substrate 20; a working surface 23 that includes a planar upper surface 24 and a chamfer 25. In particular cases, a catalyst substantially leached area may extend away from an upper surface 24 to a first predetermined depth, from a chamfer 25 to a second predetermined depth, and from a side surface 26 to a third predetermined depth.

For example, each depletion depth, as it is described above, may be from about 10 μm to about 650 μm, or it could be from about 2 μm to about 60 μm, for example. Also, for example, a third depletion depth may constitute of at least half of the overall thickness of the polycrystalline diamond table 34, but stops short of the interface 22 by at least about 650 μm, for example.

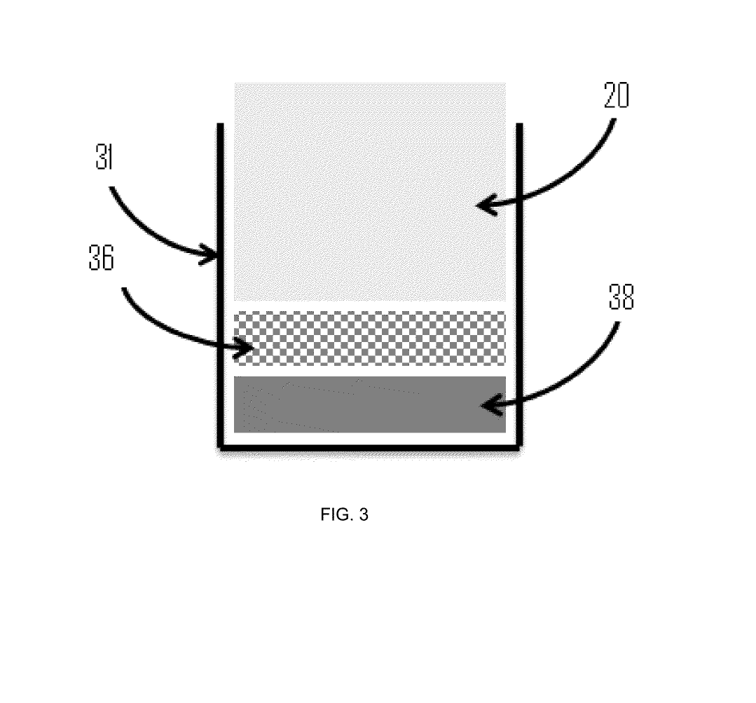

These PDC cutting elements 12 may be made in a conventional very high pressure and high temperature pressing (or sintering) operation, and then finished and machined into the cylindrical shapes shown. One such process for making these PDC cutting elements 12 may involve combining mixtures of various sized diamond crystals into diamond powder layer 36 with a pill 38 which may include graphene, or fullerene, and diamond, and substrate 20 in a tantalum cup 31 as shown in FIG. 3.

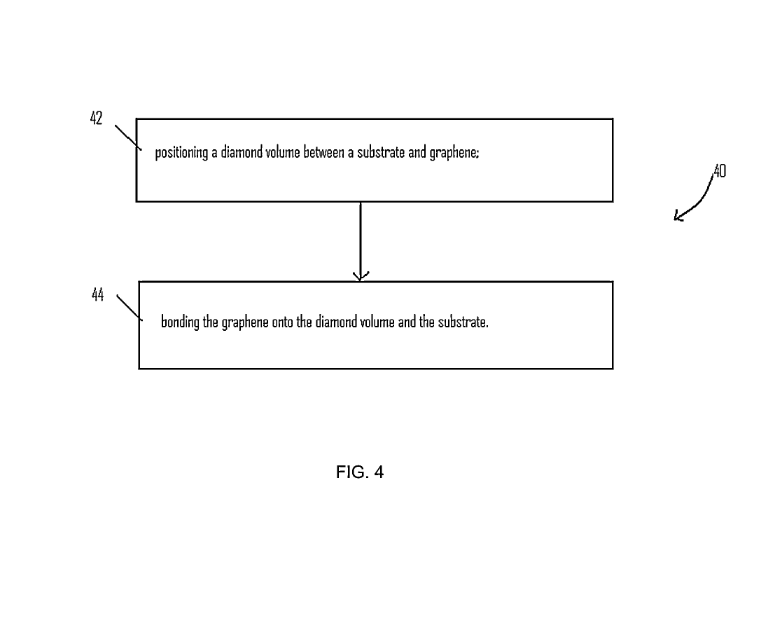

As shown in FIG. 4, a method 40 of making a cutting element may comprise steps of positioning a diamond volume between a substrate and graphene in a step 42; and converting the graphene to diamond bonded onto the diamond volume and the substrate in a step 44. More specifically, the step 42 may further include steps of positioning a diamond volume onto a substrate; disposing a pill, such as a graphene pill, adjacent to the diamond volume distal from the substrate. The step 44 may further include a step of sintering the pill to form an adhesion layer, such as polycrystalline diamond, to diamond volume and secured to the substrate.

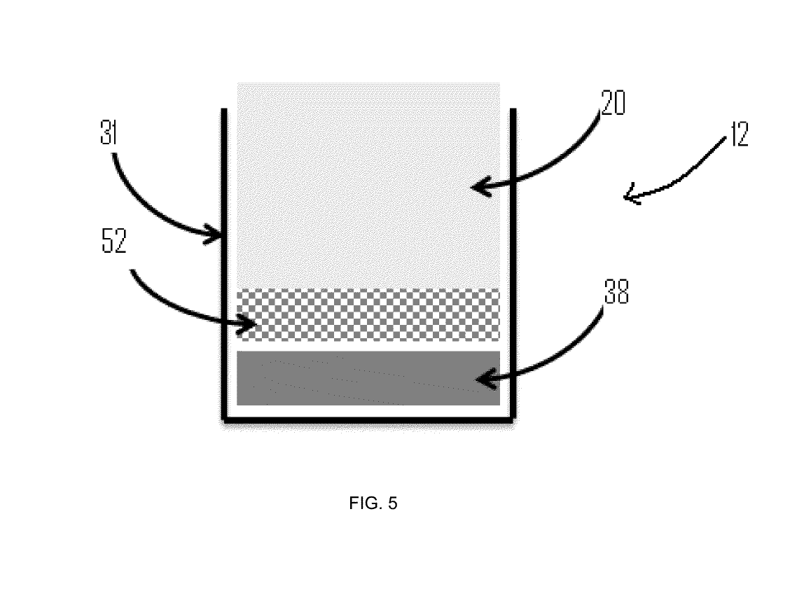

In one exemplary embodiment, diamond volume may be a mixture of various sized diamond crystals as shown in FIG. 3. In another exemplary embodiment, diamond volume may be double pressed onto the substrate as shown in FIG. 5.

Forming these cutting elements 12 with more than one HPHT cycle may be called ‘double pressing’. But the process for manufacture may be difficult, costly and cause internal defects in the product. These defects may lead to limited wear life of the resulting product. In particular, HPHT sintering of round discs onto a PDC in a second press cycle may lead to cracking of the diamond layer due to stresses developed during the process.

An alternate process for double pressing PDC cutting elements as described herein may involve an HPHT sintered PDC which includes diamond table 52 and the substrate 20. Previously pressed PDC material may have substantially all metallic materials removed from its crystalline structure by, for example, acid leaching. The graphene or fullerene, such as a graphene or fullerene pill 38, may then be layered (or otherwise dispersed) and assembled with a sintered PDC cutting element, as shown in FIG. 5, for HPHT sintering. Alternatively, the diamond table 52 may be used without acid leaching and may be rich in catalytic material, such as cobalt.

In one exemplary embodiment, the double press onto the substrate may include a first press at higher temperature than catalyst melting point, to affect standard polycrystalline diamond sintering, and a second press at temperature lower than catalyst melting point. Under the second press at temperature lower than catalyst melting point, the catalyst, such as cobalt, does not melt and graphene or fullerene may convert to polycrystalline diamond without the aid of catalyst.

### EXAMPLE 1

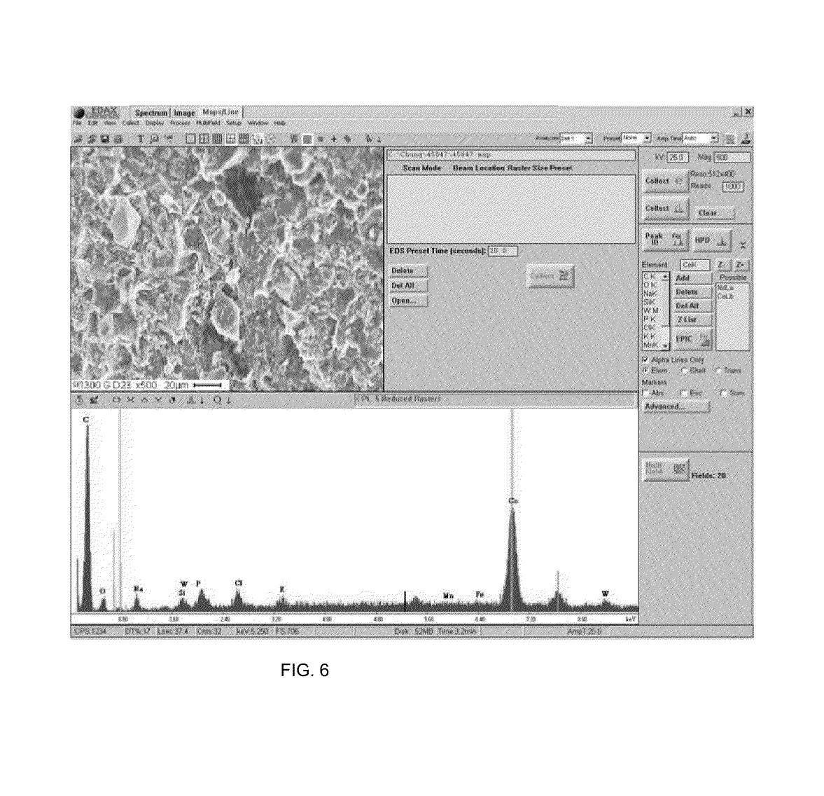

0.1 g of graphene was pressed into a 13 mm diameter pill which was placed in a Ta cup. Diamond powder (1.1 g) was then put into the Ta cup and then capped with a tungsten carbide (WC) cylinder to seal the cup. This assembly was loaded into a high pressure cell and pressed at 75 kBar and 1300˜1600° C. for a few minutes, then brought back to atmospheric pressure and recovered from the high pressure cell. The Ta layer was removed by grinding. Raman analysis on the sintered materials revealed the presence of both diamond and graphite. There were no graphene peaks (about 1600 cm⁻¹ & 2700 cm⁻¹) being detected. In FIG. 6, SEM analysis showed the presence of Co within the sintered diamond layer.

### EXAMPLE 2

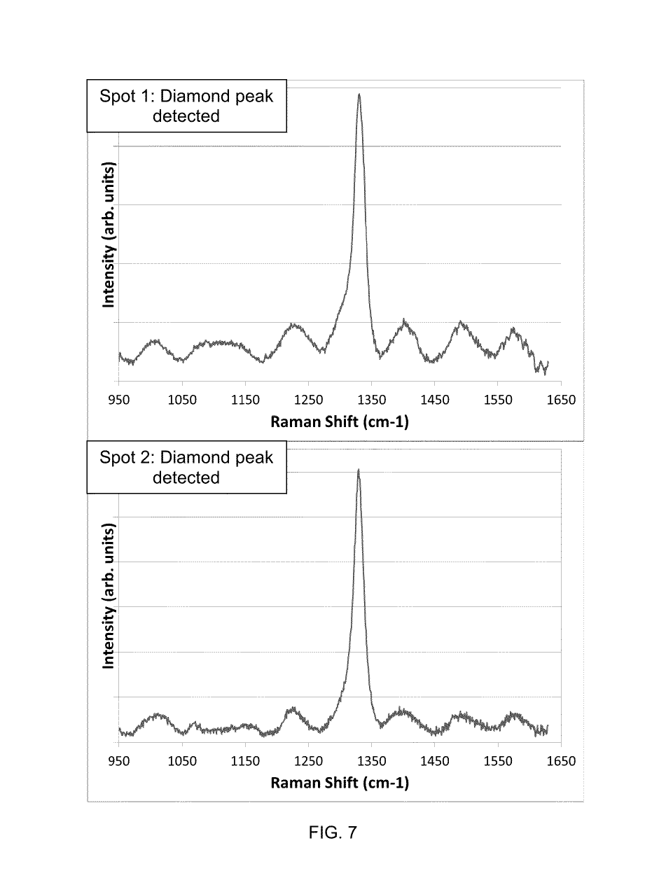

Ta cups were filled with loose graphene powder (0.1 to 0.22 g). Then, sintered PDC on a WC substrate, as shown in FIG. 5, was loaded into the cups. After drying these assemblies in vacuum at 105° C. for at least 72 hours, they were put into high pressure cells and pressed at 75 kBar and 1300° C. for a soak time of 10 minutes. Under optical microscopy, the sintered PDC exhibited dark regions, visually free of metal. Raman spectroscopy, FIG. 7 showed that these dark regions are diamond, which appear to have been formed from graphene.

### EXAMPLE 3

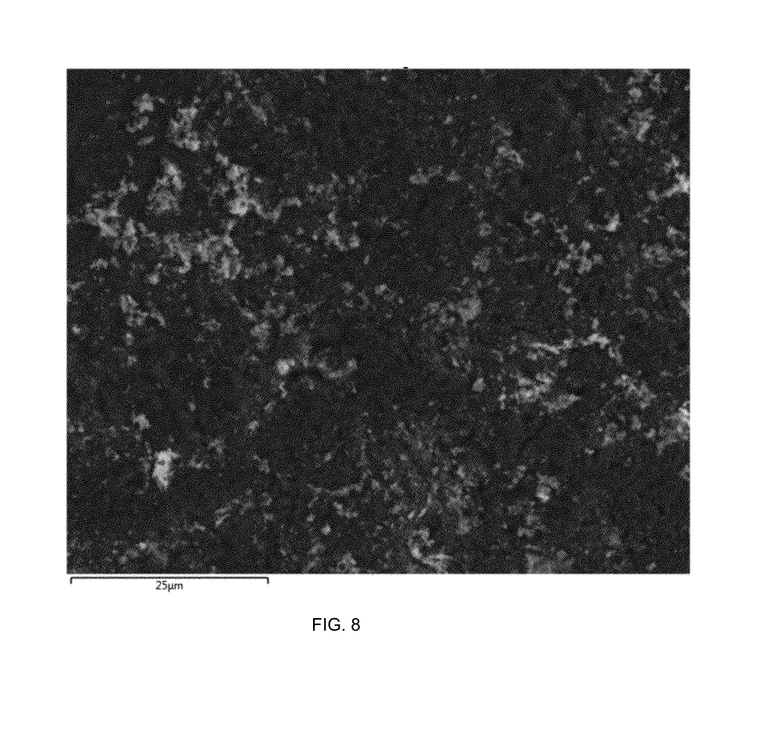

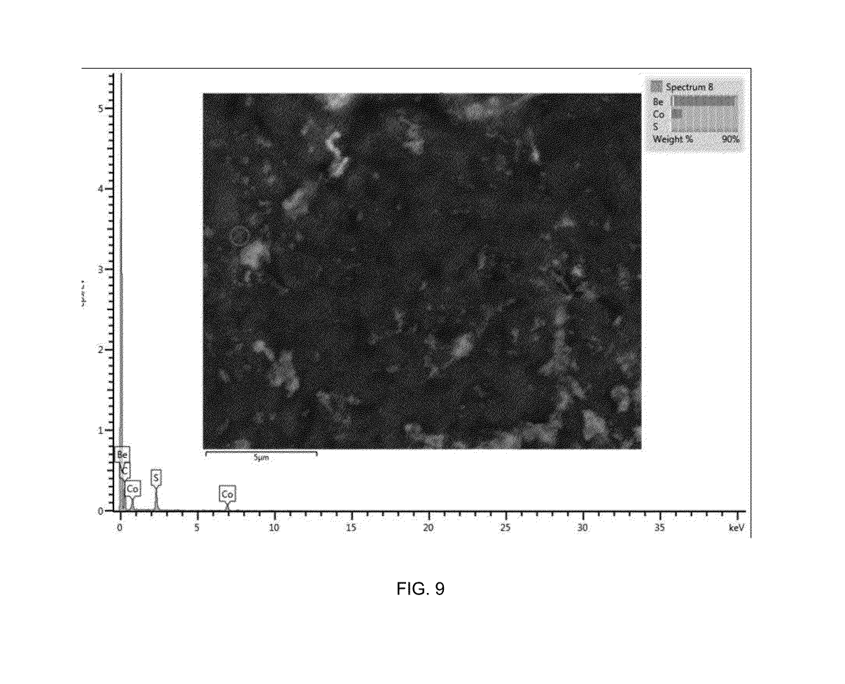

In a third embodiment, Ta cups were loaded with graphene pill of approximate weight 0.9 to 0.95 g. A sintered PDC on a WC substrate was loaded and the assembly dried. Pressing was done at 75 kBar and 1300° C. for soak time of 8 minutes. Visually, these samples appeared different from standard PDC in that they appeared to have ‘wrinkles’ and some cracks, and did not appear to have reflective metal regions on the surface when observed in the optical microscope. SEM images (FIG. 8) of the working surface shows dark and light regions. Under higher magnification (FIG. 9) these are more distinct and energy dispersive analysis by X-rays (EDS) shows C, Co, and S. The sulfur (S) presumably was originally present in the graphene. The amount of Co is significantly lower than what would be observed in standard PDC. It appears that graphene has converted to diamond when it was in contact with a diamond grain. However, if graphene was in contact with metal (such as Co), it did not convert to diamond. This leads to the lighter and darker regions observed in SEM.

The samples were OD ground to 16 mm and chamfered (0.016″) prior to testing their abrasion resistance. Diamond PDC cutters were subjected to abrasion test, representing a standard vertical turret lather test using flushing water as a coolant (VTL-c). The PDC cutter was oriented at a 15° back rake angle against the surface of Barre Gray Granite rock wheel having a 1.82 m diameter. Such rock materials may comprise a compressive strength of about 200 MPa. The tested cutter traveled on the surface of the granite wheel while the cutting element was held constant at a 0.36 cm depth of cut and the feed was 0.36 mm/revolution.

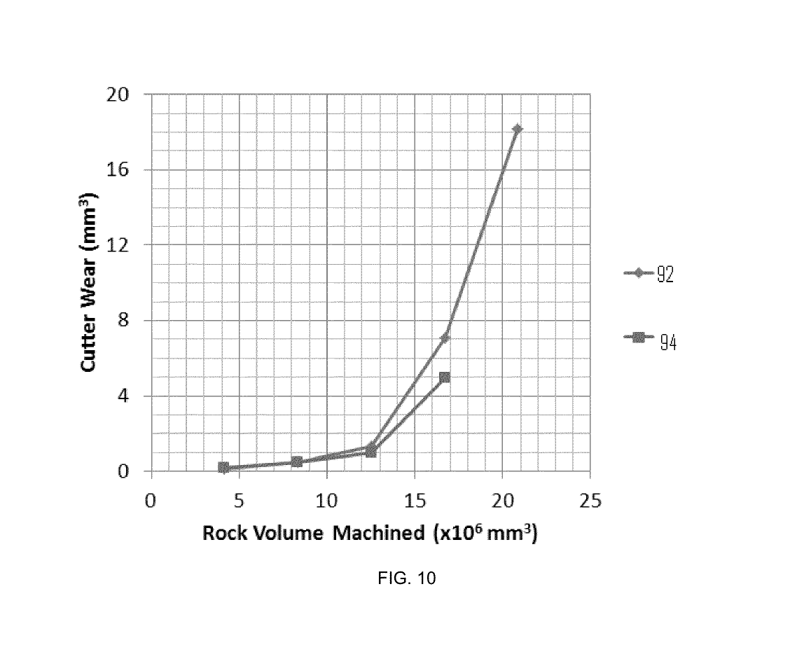

The wear curve (FIG. 10) compares the results for a standard PCD cutter 92 and one with graphene 94. As can be seen, the early wear behavior was similar, but as wear increased, some improvement in performance could be attributed the cutter with graphene derived diamond. As the amount of wear on the cutter increases, the thermal load increases significantly. This improvement in late-stage wear correlates to an improvement in thermal stability of the cutter.

### EXAMPLE 4

The similar experiments as example 3 were done except that PDC cutters were chemically etched in acid solutions and then boiled in deionized water to clean from etching deposits. Different etching times provided PDC cutters with different Co depletion depths from the surface, such as from 10 to 200 μm deep. Co depletion depth was measured by SEM on sample cross-sections obtained after completion and subsequent abrasion tests. Several etched cutters were further used for diamond coating and others were used as the references in abrasion tests.

Although described in connection with preferred embodiments thereof, it will be appreciated by those skilled in the art that additions, deletions, modifications, and substitutions not specifically described may be made without departure from the spirit and scope of the invention as defined in the appended claims.

What is claimed is:

1. A cutting element for a tool, comprising:
a substrate;
a polycrystalline diamond table bonded to the substrate; and
a diamond volume substantially free of catalytic material attached to the polycrystalline diamond table, wherein the polycrystalline diamond table is sandwiched between the substrate and the diamond volume substantially free of catalytic material, wherein the substantially free of catalytic material on diamond volume is not a result of a leaching process.

2. The cutting element of claim 1, wherein the diamond volume substantially free of catalytic material is converted from graphene or fullerene.

3. The cutting element of claim 1, wherein catalytic material is present as a sintering aid in manufacturing the polycrystalline diamond table.

4. The cutting element of claim 1, wherein the substrate is a cemented carbide substrate.

5. The cutting element of claim 1, wherein the polycrystalline diamond table is rich in catalytic material.

6. The cutting element of claim 1, wherein the polycrystalline diamond table is a leached polycrystalline diamond table.

7. The cutting element of claim 1, wherein the polycrystalline diamond table is double pressed to the substrate.

8. The cutting element of claim 1, wherein the diamond volume substantially free of catalytic material has a bevel at a peripheral edge.

9. A method of making a cutting element, comprising:
positioning a diamond volume between a substrate and graphene; and
converting graphene into a coherent layer bound onto the diamond volume and the substrate.

10. The method of claim 9, wherein the diamond volume is double pressed onto the substrate.

11. The method of claim 9, wherein the bonding includes pressing the graphene onto the diamond volume and the substrate at high pressure and high temperature.

12. The method of claim 10, wherein a first press is at higher temperature than catalyst melting point and a second press is at a temperature lower than catalyst melting point.

13. The method of claim 9, wherein the coherent layer comprises polycrystalline diamonds.

14. The method of claim 9, wherein the diamond volume acts as seeds for graphene to convert to polycrystalline diamond.

15. A method of making a cutting element, comprising:
positioning a diamond volume onto a substrate;
disposing a pill adjacent to the diamond volume distal from the substrate; and
sintering the pill to form a layer adhered to diamond volume and secured to the substrate.

16. The method of claim 15, wherein the adhered layer comprises polycrystalline diamond.

17. The method of claim 15, wherein the pill is a graphene pill or a fullerene pill.

18. The method of claim 15, wherein sintering further includes converting the pill to polycrystalline diamond.

19. The method of claim 15, wherein the diamond volume comprises a diamond table.

20. The method of claim 19, wherein the diamond table is rich in catalytic material.

21. The method of claim 19, wherein the diamond table is substantially leached.

22. The method of claim 19, wherein the diamond table is double pressed onto the substrate.

23. The method of claim 22, wherein the double press onto the substrate includes a first press at higher temperature than catalyst melting point and a second press at temperature lower than catalyst melting point.
